(19) United States
(12) Patent Application Publication
(10) Pub. No.: US 2009/0251067 A1
(43) Pub. Date: Oct. 8, 2009

(54) PULSED LED ILLUMINATION TO SAVE ENERGY

(76) Inventor: PAUL K. JOHNSON, WEST DES MOINES, IA (US)

Correspondence Address: MCKEE, VOORHEES & SEASE, P.L.C., 801 GRAND AVENUE, SUITE 3200, DES MOINES, IA, 50309-2721, US

(21) Appl. No.: 12/416,260

(22) Filed: Apr. 1, 2009

Related U.S. Application Data
(60) Provisional application No. 61/041,727, filed on Apr. 2, 2008.

(51) Int. Cl. H05B 37/02; H01J 1/62

(52) U.S. Cl. 315/294; 313/504

(57) ABSTRACT

A method for providing lighting includes sweeping an array of light sources on and sweeping the array of light sources off. The array of light sources being swept on and off at a frequency substantially higher than a critical flicker frequency to enhance perceived brightness. An apparatus includes a plurality of light sources organized in a matrix and an intelligent control electrically connected to the plurality of light sources, wherein the intelligent control being adapted to sweep the light sources on and sweep the light sources off at a frequency substantially higher than a critical flicker frequency to provide enhanced perceived brightness.

### CROSS-REFERENCE TO RELATED APPLICATIONS

This application claims priority under 35 U.S.C. § 119 of a provisional application Ser. No. 61/041,727 filed Apr. 2, 2008, which application is hereby incorporated by reference in its entirety.

### FIELD OF THE INVENTION

The present invention relates to lighting and more particularly to energy efficient lighting.

### BACKGROUND OF THE INVENTION

Persistence of vision is well known. Also well known is the use of illumination devices to overcome flicker by use of persistence of vision such as commonly associated with movie projectors. It is also known that on cathode ray tube (CRT) displays, increasing the refresh rate also decreases perceived flickering. Therefore, intermittent light sources are well known to provide persistence of vision.

In the field of vision sciences, Talbot and Plateau (1834 and 1835) were able to determine the rules that govern the perceived brightness of intermittent light sources flickered at rates above the Critical Flicker Frequency (CFF). Their results, now known as the “Talbot Plateau Law”, showed that:
The perceived brightness of a “fused” intermittent light source is the same as it would be if the same total stimulation were distributed uniformly throughout the whole cycle.

Thus, the Talbot-Plateau Law states that the brightness of intermittent light is equal to the brightness of steady light with the same time-averaged luminance. For the Talbot-Plateau Law to apply, the intermittent light must illuminate at a rate beyond the Critical Flicker Frequency (CFF), which is the frequency at which flicker induced by intermittent illumination disappears.

### BRIEF SUMMARY OF THE INVENTION

Increased “brightness” can be achieved by implementing intermittent illumination at temporal frequencies above the CFF. That is, intermittent, but perceptually fused lights will appear brighter than equal total energy continuous lights. This is contrary to the “Talbot Plateau law” and, since increased brightness above the CFF is achieved, then it is occurring due to other physiological phenomena not currently known, recognized and/or understood.

According to one aspect of the present invention, a method for providing lighting includes sweeping an array of light sources on and sweeping the array of light sources off. The array of light sources being swept on and off at a frequency substantially higher than a critical flicker frequency to enhance perceived brightness.

According to another aspect of the present invention, an apparatus is provided. The apparatus includes a plurality of light sources organized in a matrix and an intelligent control electrically connected to the plurality of light sources, wherein the intelligent control being adapted to sweep the light sources on and sweep the light sources off at a frequency substantially higher than a critical flicker frequency to provide enhanced perceived brightness.

### BRIEF DESCRIPTION OF THE DRAWINGS

FIG. 1 is a pictorial representation of one embodiment of the present invention.

FIG. 2A is a view of a bank of LEDs at different points in time with scanning of LEDs to increase perceived brightness of the LEDs.

FIG. 2B is a view of the bank of LEDs at different points in time with scanning of the LEDS to increase perceived brightness of the LEDs.

FIG. 3 illustrates a bank of LEDs which is constantly on and a bank of LEDs which is sweep on.

FIG. 4 illustrates a block diagram of a circuit for controlling a bank of LEDs.

FIG. 5 illustrates examples of energy efficient lighting provided with the present invention.

### DETAILED DESCRIPTION OF THE PREFERRED EMBODIMENT

The present invention relates to providing for improving lighting efficiency by sweeping an array of light sources at a frequency sufficient to increase the perception of brightness. In contradiction to the Talbot-Plateau Law, the present invention provides for increasing perceived brightness at rates above the Critical Flicker Frequency. The present invention provides for numerous possible applications, including enhancing the perceived brightness of lighting or providing the same level of perceived brightness with less energy than would be required to have lighting in a continuously on state.

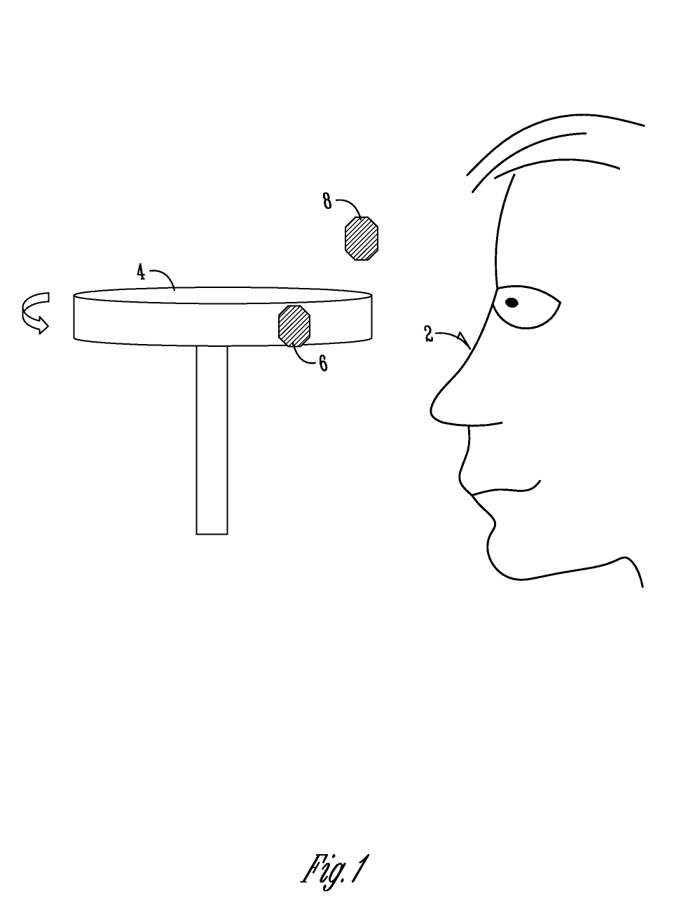

FIG. 1 illustrates a block diagram of one example of a test setup. An observer 2 may compare perceived brightness of a control light source 8 with a test light source 6. The test light source 6 may be rotated on a platen 4 at different frequencies to determine the frequency at which the test light source 6 appears to have the same or greater brightness as the control light source 8.

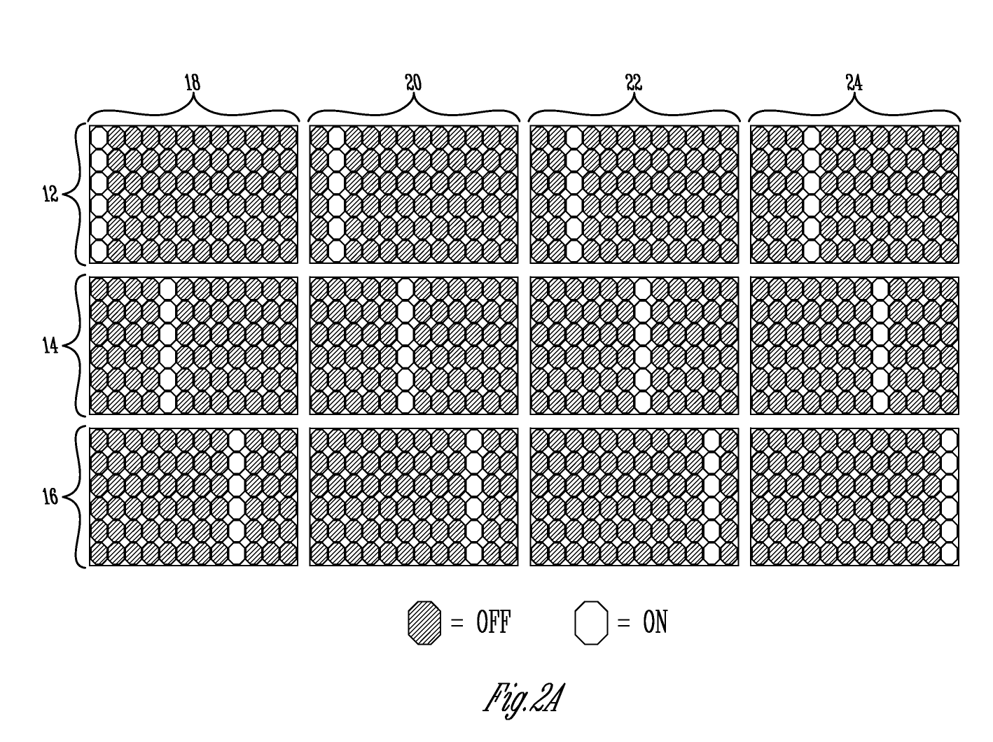

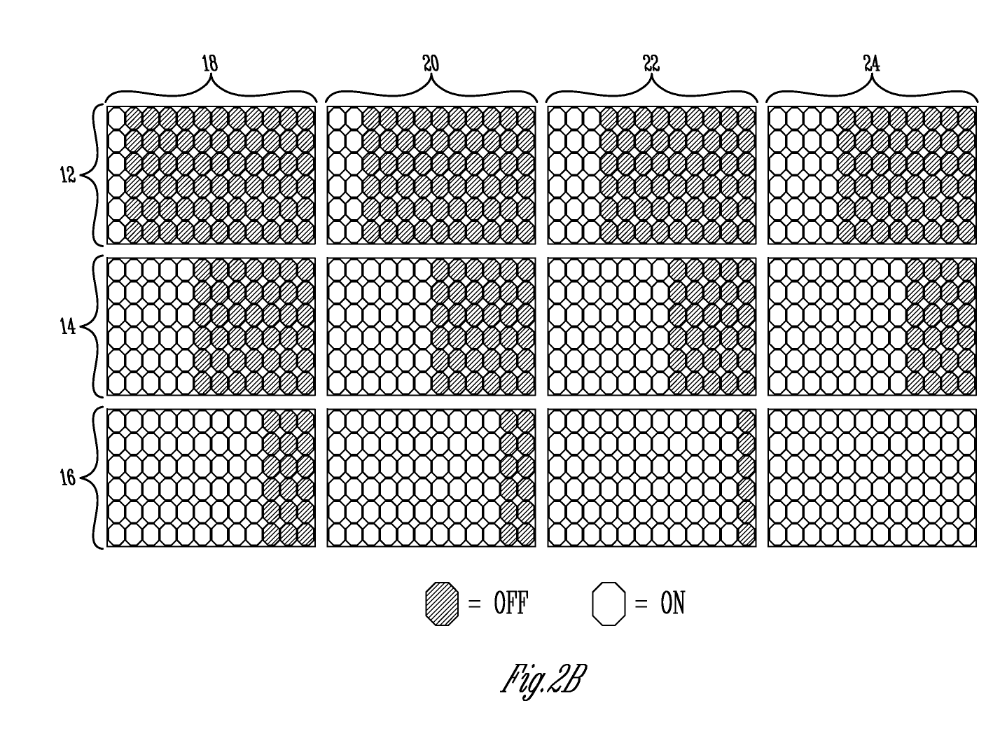

FIG. 2A is a view of a bank of LEDs at different points in time with scanning of LEDs to increase perceived brightness of the LEDs. The same bank of LEDs is shown 12 different times to indicate the state of the LEDs at different points in time. The bank of LEDs is a bank or matrix of 12×6 LEDs, the size of which is merely provided for illustration purposes. The present invention contemplates any size of bank of LEDs. The bank of LEDs is shown at 12 different points in time during scanning of the LEDs across the bank to increase perceived brightness. There are rows 12, 14, 16 and columns 18, 20, 22, 24. In operation, a single line of LEDs is switched on at each interval in time to provide the effect of the bank of LEDs being continuously on. Although a single vertical line is shown, the present invention also contemplates that a single horizontal line may be used instead. In addition, the present invention contemplates that instead of scanning a single line of LEDS, multiple lines of LEDS may be turned on at the same time.

FIG. 2B illustrates another embodiment of the present invention, where lines of LEDs remain on as they are swept across. The sweep may be reversed after the progression is complete, so that each vertical line of LEDs is turned off.

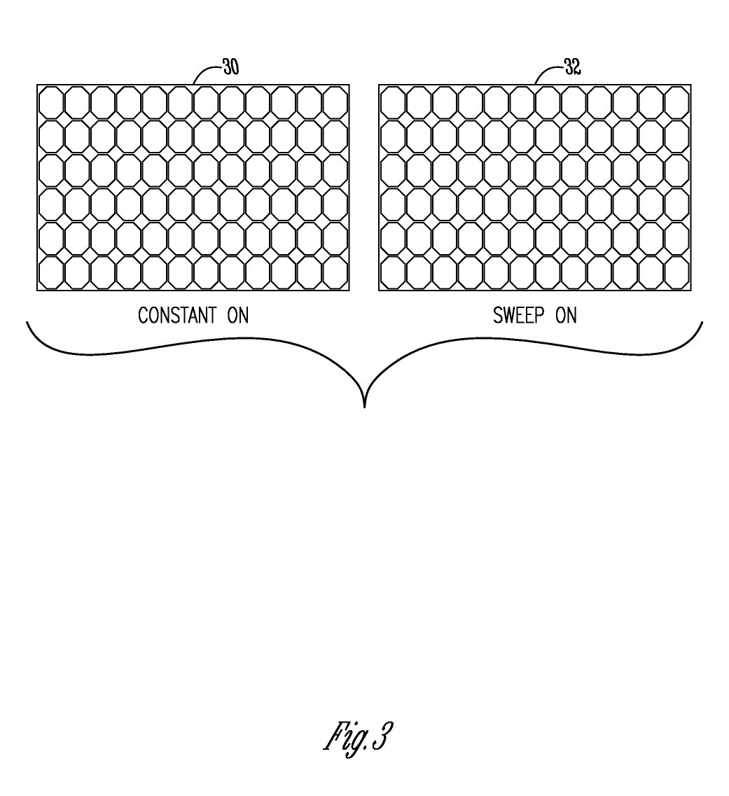

FIG. 3 illustrates a bank of LEDs which is constantly on and a bank of LEDs which is swept on as perceived by a person. Where the frequency of the sweeping is sufficient the present inventor postulates that the perceived brightness of the bank of LEDs which is swept on may be equal to or greater than the perceived brightness of the bank of LEDs which is constantly on. This allows for the possibility of a gain in efficiency. That is to say, to achieve the same perceived brightness, the bank of LEDs need not be constantly on.

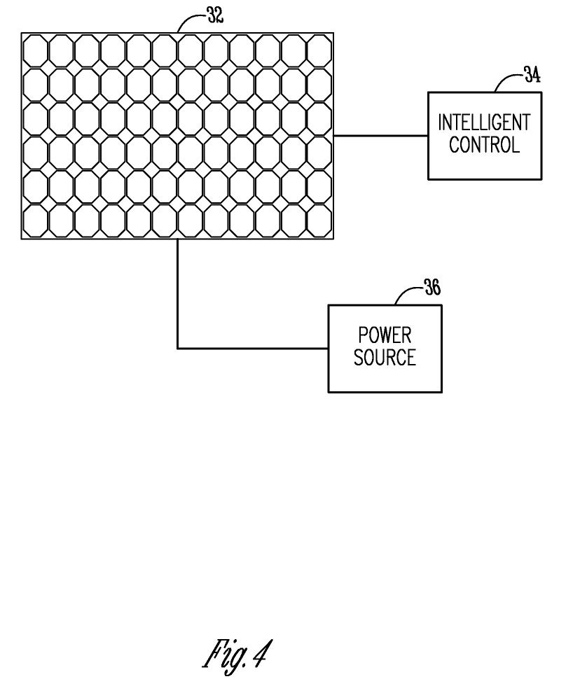

FIG. 4 illustrates a block diagram of a circuit for controlling a bank of LEDs. As shown in FIG. 4, an intelligent control 34 is electrically connected to a light source 32 which is configured to be swept on to increase perceived brightness. The light source 32 may be a matrix of LEDs or other types of light sources. The light source 32 is also connected to a power source 36.

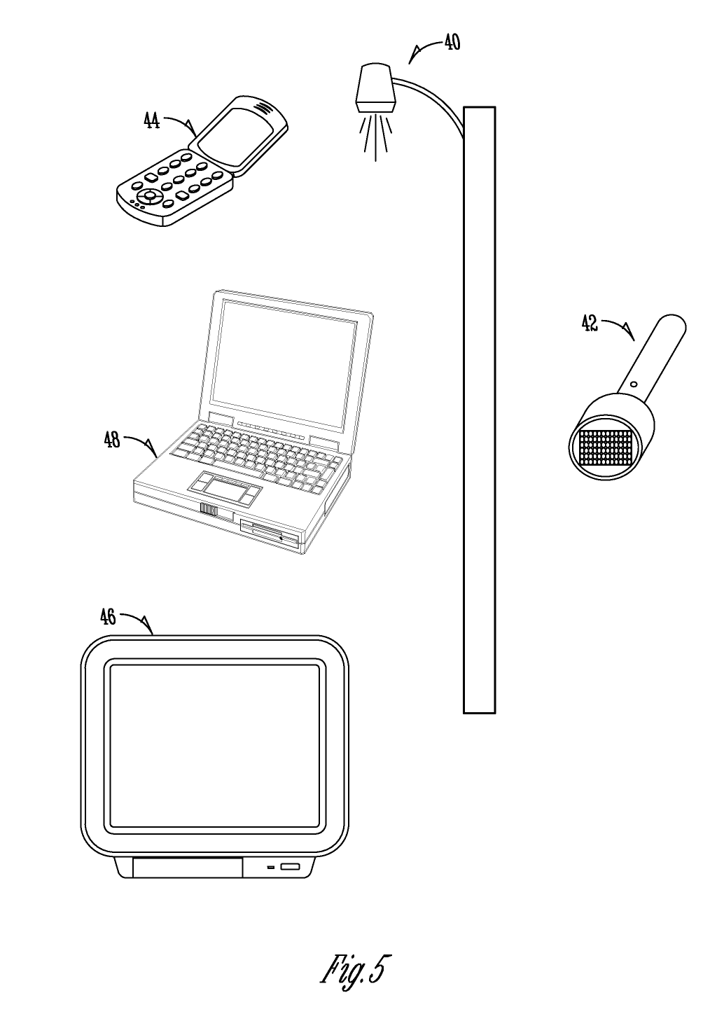

FIG. 5 illustrates examples of energy efficient lighting provided with the present invention. One example is a street light 40. The street light 40 includes a plurality of LEDs. The present invention contemplates that there may be other advantages from the use of swept illumination. For example, there may be reduced heating of light sources, or possibly increased life of the light sources.

Another example is a flashlight 42 so as may be operated by battery power. The present invention contemplates that by sweeping light sources of the flashlight on, reduced power is needed to operate the flashlight thereby extending battery life of the device.

These are merely a few of many examples of devices in which the present invention may provide a means of increasing energy efficiency. Other examples include the backlighting associated with liquid crystal displays as may be used on any number of electronic devices, including battery operated devices, such as, televisions, notebook computers, cellular phones, and personal entertainment devices such as MP3 players and video games.

It is important to recognize that the present invention relates to an observed effect which is inconsistent with the Talbot-Plateau Law and different from mere persistence of vision. In particular, the present invention relates not merely to timing the turning on and off of light sources to achieve persistence of vision, but rather the timing of the turning on and off of light sources in order to enhance perceived brightness. The frequency necessary to enhance brightness is greater than the frequency needed to obtain persistence of vision.

In an initial testing, 20 subjects were subjected to five measurements to assess relative perceived brightness between a light source at a brightness and a mechanically swept illumination. The mean of the sample of 20 subjects is highly significantly different (P<0.01) from 1.0 (no efficiency gains), indicating a statistically significant difference in efficiency for these 20 subjects. The average measured efficiency gain was 35 percent, and it ranged from 68 percent to 10 percent in this sample. It is to be appreciated that different individuals may be more or less perceptive of perceived brightness.

| Subject | Mean Data |
|---|---|
| 1 | 1.564 |
| 2 | 1.465 |
| 3 | 1.311 |
| 4 | 1.377 |
| 5 | 1.169 |
| 6 | 1.446 |
| 7 | 1.396 |
| 8 | 1.571 |
| 9 | 1.297 |
| 10 | 1.09 |
| 11 | 1.261 |
| 12 | 1.101 |
| 13 | 1.307 |
| 14 | 1.266 |
| 15 | 1.235 |
| 16 | 1.292 |
| 17 | 1.293 |
| 18 | 1.683 |
| 19 | 1.627 |
| 20 | 1.2 |
| Sample mean | 1.34755 |
| Sample SD | 0.16753271 |

The above data supports that enhanced brightness is perceived for swept illumination. The present invention provides for extending the mechanical implementation to an electronic implementation where LEDs are used as the light source. LEDs, and especially OLEDs, are generally recognized as providing efficiencies in lighting and can be readily controlled through electronics.

Lighting intensity of LEDs is typically controlled by means such as increasing or decreasing current to the LEDs or else varying the current to the LEDs through pulse width modulation. Of course, such means provide for controlling lighting intensity within a range of brightness. The present invention provides for extending the range of perceived brightness, through a control system which sweeps the lighting at a frequency which is greater than the flicker frequency and sufficient to provide an increase in perceived brightness.

Increasing perceived brightness may have one of a number of advantages depending upon the particular context in which it is used. First, light sources having a particular maximum brightness may have their perceived brightness increased beyond the maximum brightness. An appropriate control system may be used to retrofit or accessorize existing lighting application. Alternatively, the idea of perceived brightness may be considered when a lighting system is first designed to provide additional design alternatives.

Thus, for example, lower cost light sources or more energy efficient light sources may be used.

A further advantage of the energy efficiency may be achieved by the present invention because increased perceived brightness is achieved without increasing current to the lighting. Thus, the same perceived brightness can be obtained with less energy.

The present invention contemplates numerous variations. This includes variations in the type of light source, including LED, incandescent, fluorescent, gas tube, or otherwise. The present invention contemplates variations in the manner in which the light sources are swept including mechanically or electronically. The present invention contemplates variations in the frequency of the sweeping providing the frequency is above the CFF and provides an enhanced perceived brightness effect. The present invention contemplates numerous variations in the specific application of the present invention, including to street lights, flash lights, LCD back lighting, and other applications. These and other variations, options, and alternatives are within the spirit and scope of the invention.

What is claimed is:

1. A method for providing lighting, comprising:
sweeping an array of light sources on;
sweeping the array of light sources off;
wherein the array of light sources being swept on and off at a frequency substantially higher than a critical flicker frequency to enhance perceived brightness of the lighting.

2. The method of claim 1 wherein the array of light sources is an array of LEDs.

3. The method of claim 2 wherein the array of LEDs provides backlighting.

4. The method of claim 1 wherein the array of light sources includes a plurality of rows and a plurality of columns.

5. The method of claim 4 wherein the array of light sources being swept on and off one column at a time.

6. The method of claim 4 wherein the array of light sources being swept on and off a plurality of columns at a time.

7. The method of claim 4 wherein the array of light sources being swept on and off one row at a time.

8. The method of claim 4 wherein the array of light sources being swept on and off a plurality of rows at a time.

9. An apparatus, comprising:
a plurality of light sources organized in a matrix;
an intelligent control electrically connected to the plurality of light sources, wherein the intelligent control being adapted to sweep the light sources on and sweep the light sources off at a frequency substantially higher than a critical flicker frequency to provide enhanced perceived brightness.

10. The apparatus of claim 9 wherein each of the plurality of light sources is an LED.

11. The apparatus of claim 10 wherein each LED is an OLED.

12. The apparatus of claim 9 wherein the sweep is a vertical sweep.

13. The apparatus of claim 9 wherein the apparatus is an outdoor lighting system.

14. The apparatus of claim 13 wherein the apparatus is a street light.

15. The apparatus of claim 9 wherein the plurality of light sources provides backlighting for an electronic device.
